(19) United States
(12) Patent Application Publication
(10) Pub. No.: US 2025/0012687 A1
(43) Pub. Date: Jan. 9, 2025

(54) METAL-POLYMER INTERFACIAL BONDING TEST APPARATUS AND MANUFACTURING METHOD FOR EXTREME CONDITIONS

(71) Applicant: The Florida State University Research Foundation, Inc., Tallahassee, FL (US)

(72) Inventors: Rebekah Sweat, Tallahassee, FL (US); Peter Graham Cheetham, Tallahassee, FL (US); Ana De Leon, Tallahassee, FL (US)

(21) Appl. No.: 18/764,741

(22) Filed: Jul. 5, 2024

Related U.S. Application Data
(60) Provisional application No. 63/511,913, filed on Jul. 5, 2023.

(51) Int. Cl. G01N 3/08; B29C 33/12; B29C 33/38

(52) U.S. Cl. CPC G01N 3/08; B29C 33/12; B29C 33/38; B29K 2905/00; G01N 2203/0228

(57) ABSTRACT

Various implementations described herein include methods and systems for characterizing material properties at cryogenic temperatures that are suitable for studying epoxy and metal interfaces. One implementation include a mold for forming composite samples for a pullout test. Various other implementations include a method of forming a composite sample for a pullout test.

### CROSS-REFERENCE TO RELATED APPLICATIONS

This application claims priority to and the benefit of U.S. Provisional Application No. 63/511,913, titled “METAL-POLYMER INTERFACIAL BONDING TEST APPARATUS AND MANUFACTURING METHOD FOR EXTREME CONDITIONS”, filed on Jul. 5, 2023, the content of which is hereby incorporated by reference herein in its entirety.

### BACKGROUND

Due to safety regulations, the certification of materials (e.g., metal tapes, metal epoxies, and the like) for the power, aerospace, and automotive industries must be performed before a product form can be in service. These composites are expected to resist complex loading and harsh environments; therefore, they must retain their mechanical performance at quasi-static and dynamic loading conditions. The certification process is expensive and time-consuming due to the amount of material and equipment required for full-scale tests. There is a need for methods for quantifying small amounts of materials in a repeatable fashion.

At cryogenic temperatures, the formation of voids within epoxies or delamination between an epoxy-metal interface can lead to partial discharge which will degrade electrical insulation and lead to failure of a power device or power cable, for example. In some cases, a mismatch in co-efficient of thermal expansion between a conductor and epoxy can lead to cracking when cooling down to a cryogenic temperature.

There is a need for methods and techniques for characterizing epoxy material properties for extreme conditions such as cryogenic temperatures, in particular, for studying epoxy and metal interfaces at these temperatures.

### SUMMARY

Pullout testing may be used in construction and engineering applications to determine an amount of force required to remove or pull a first material from another material (e.g., concrete or rock) in order to assess the quality and/or structural integrity of various materials. During a pullout test, a force is applied to a first material that is embedded or otherwise attached to a second material until failure of the bond between the first material and the second material. Pullout testing for manufacturing and micro-testing manufacturing is novel. For example, extreme environment (e.g., cryogenic temperatures below-150 degrees Celsius) interface testing of metal/polymer interfaces has not been successfully implemented as many materials exhibit different behavioral properties and structural changes in such environments.

A parameter that evaluates the adhesion between a material (e.g., metal material) and matrix is the interfacial shear strength (IFSS). This can be estimated through bundle pullout tests where the material is externally loaded from the matrix. This method is one of the oldest used to measure material-matrix adhesion and has improved the most in recent years. In addition, the pullout test is the most popular method to evaluate IFSS due to its versatility since it can be used in a wide range of systems. In addition, this technique provides direct measurements of interfacial adhesion relative to bulk composite methods such as the Short Beam Shear (SBS) test that measures Interlaminar Shear Strength (ILSS). Based on the sample's scale, the pullout technique can be classified as a microbond test, fiber-bundle pullout test (FBPO), and single-fiber pullout test (SFPO).

Various commercial cryogenic rated epoxies exist which have differences in cost, shelf life, and processing techniques. It may be necessary to characterize epoxy-metal interfaces for mechanical applications at cryogenic temperatures to ensure that these materials can be safely deployed in extreme environments without failure.

Embodiments of the present disclosure provide a testing method designed for evaluating the mechanical bonding between metal and polymer interfaces for cryogenic applications. By assessing the interfacial shear strength (IFSS) using a pullout method, embodiments of the present disclosure address delamination challenges that have been reported in the past. Delamination can cause void formation, leading to partial discharge and limiting the operating voltage range and the lifetime of high-temperature superconducting (HTS) devices. In some implementations, a testing method involves a custom molding process for preparing pullout test samples, which can consist of metal reinforcement and polymer material around it. Embodiments of the present disclosure enable a better understanding and improvement of the bonding between metal and polymers with direct extreme environment applications, especially relevant for cryogenic applications.

Embodiments of the present disclosure provide small metal/polymer interface samples that are easy to manufacture and test in extreme environments. Additional benefits include high data resolution compared to standard peel tests and the ability to examine fractured samples post-test to understand more about the break strength. Samples are significantly smaller than the current state-of-the-art, resulting in less wastage of expensive materials.

In some implementations, a mold for forming composite samples for a pullout test for high temperature superconducting (HTS) devices suitable for cryogenic temperatures is provided. The mold can include: a body having a first surface and a second surface spaced apart from the first surface, wherein the first surface defines one or more slots and one or more channels, wherein each of the one or more channels has a longitudinal axis, and wherein at least one of the channels intersects one of the slots.

In some implementations, the composite samples include metal material and polymer.

In some implementations, at least one channel intersecting the one or more slots includes two channels.

In some implementations, longitudinal axes of the two channels are collinear.

In some implementations, the body has an end surface extending between the first surface and the second surface, wherein at least one of the channels extends to the end surface.

In some implementations, the end surface defines at least one groove having a longitudinal axis, wherein the longitudinal axis of at least one channel intersects the longitudinal axis of the at least one groove.

In some implementations, each of the one or more slots are discorectangular shaped as viewed in a plane defined by the first surface.

In some implementations, each of the one or more slots has a longitudinal axis and the longitudinal axis of at least one of the channels intersecting the one or more slots is parallel to the longitudinal axis of the one or more slots.

In some implementations, the longitudinal axis of at least one of the channels intersecting the one or more slots is collinear with the longitudinal axis of the one or more slots.

In some implementations, each of the one or more slots has a longitudinal axis and the longitudinal axes of the two channels intersecting the one or more slots are parallel to the longitudinal axis of the one or more slots.

In some implementations, the mold is configured as an open-face mold or a close-face mold.

In some implementations, the mold includes at least one of a metal reinforcement or fiber reinforcement.

In some implementations, a system for conducting a pullout test on formed composite samples in a cryogenic environment is provided. The system can include: a mold, the mold including: a body having a first surface and a second surface spaced apart from the first surface, wherein the first surface defines one or more slots and one or more channels, wherein each of the one or more channels has a longitudinal axis, wherein at least one of the channels intersects at least one of the slots; and a testing fixture defining a fixture opening, wherein a size and a shape of at least a portion of the fixture opening corresponds to a size and a shape of at least a portion of the one or more slots such that a composite sample formed within the portion of the one or more slots is disposable within the fixture opening.

In some implementations, the system further includes a tensile testing machine, wherein the testing fixture is couplable to the tensile testing machine.

In some implementations, a method of forming a composite sample for a pullout test in a cryogenic environment is provided. The method can include: providing a mold for forming composite samples for a pullout test, the mold including: a body having a first surface and a second surface spaced apart from the first surface, wherein the first surface defines one or more slots and one or more channels, wherein each of the one or more channels has a longitudinal axis, wherein at least one of the channels intersects at least one of the slots; disposing a polymer within the one or more slots; disposing a test material within at least one of the channels intersecting the one or more slots such that a portion of the test material is disposed within the one or more slots; and causing the polymer to cure.

In some implementations, the method further includes: removing the test material from the mold; performing the pullout test on the test material; and determining, via a testing instrument or at least one electronic circuit, one or more characteristics of the test material during the pullout test.

In some implementations, the pullout test is a microbond test, fiber-bundle pullout test (FBPO), or single-fiber pullout test (SFPO).

In some implementations, the pullout test is performed at a temperature between 77 K and 120 K.

In some implementations, the method further includes: applying a compression force on the mold prior to causing the polymer to cure.

In some implementations, the test material includes an epoxy-metal interface.

### BRIEF DESCRIPTION OF DRAWINGS

Example features and implementations are disclosed in the accompanying drawings. However, the present disclosure is not limited to the precise arrangements and instrumentalities shown.

FIG. 1A is a top view and end view of a mold for forming composite samples for a pullout test, according to one implementation.

FIG. 1B is a side view of a testing fixture used to perform pullout tests on composite samples formed with the mold of FIG. 1A.

FIG. 1C is a perspective view of the mold of FIG. 1A.

FIGS. 2A-2G are a flow chart of the steps of using the mold of FIG. 1A to form a composite sample for a pullout test in accordance with certain implementations described herein.

FIG. 3A is a flow chart of an example method of manufacture in accordance with certain implementations described herein.

FIG. 3B and FIG. 3C are views of example molds, in accordance with certain embodiments described herein.

FIG. 3D and FIG. 3E show example molds, in accordance with certain embodiments described herein.

FIGS. 4A-4G is a series of images illustrating an example pullout test in a custom mechanical fixture.

FIG. 5A-5D show experimental results from a study that was conducted.

FIG. 6A shows an experimental setup used for Ic measurements.

FIG. 6B shows an electrode arrangement used for breakdown measurements.

FIG. 6C shows Weibull probability plots of the breakdown electric field for EP1 and EP2 specimens at room temperature and 77 K.

FIG. 6D shows the visual damage to the samples caused by the breakdown events.

FIGS. 7A-7D shows a custom molding process used to cast the pullout specimens.

FIG. 8 depicts stress/displacement curves of interfacial tests conducted between different epoxies and stainless steel.

FIG. 9 shows the results of the dynamic mechanical analysis (DMA) of tested epoxies.

### DETAILED DESCRIPTION

The devices, systems, and methods disclosed herein provide for a horizontal mold that includes a metal material embedded in a matrix encapsulation, and a geometry matched testing fixture for manufacturing samples for the pullout test. The mold allows the manufacturing of both nanoscale and microscale samples. To test the devices, systems, and methods disclosed herein, SFPO and FBPO can be used to evaluate the interfacial adhesion between various materials with different polymer matrices. The effectiveness of the data can be validated based on stress vs. displacement curves, microscopical observations, and statistical analysis.

Various implementations include a mold for forming composite samples for a pullout test. The mold includes a body having a first surface and a second surface spaced apart from the first surface. The first surface defines one or more slots and one or more channels. Each of the one or more channels has a longitudinal axis. At least one of the channels intersects at least one of the slots.

Various other implementations include a method of forming a composite sample for a pullout test. The method includes providing a mold for forming composite samples for a pullout test, as described above; disposing a metal material (e.g., metal tape) within the one or more slots; disposing a polymer (e.g., resin or epoxy) within the at least one of the channels intersecting the one or more slots such that a portion of the metal material is disposed within the one or more slots; and causing the polymer to cure.

### Example Interface Sample Preparation and Method

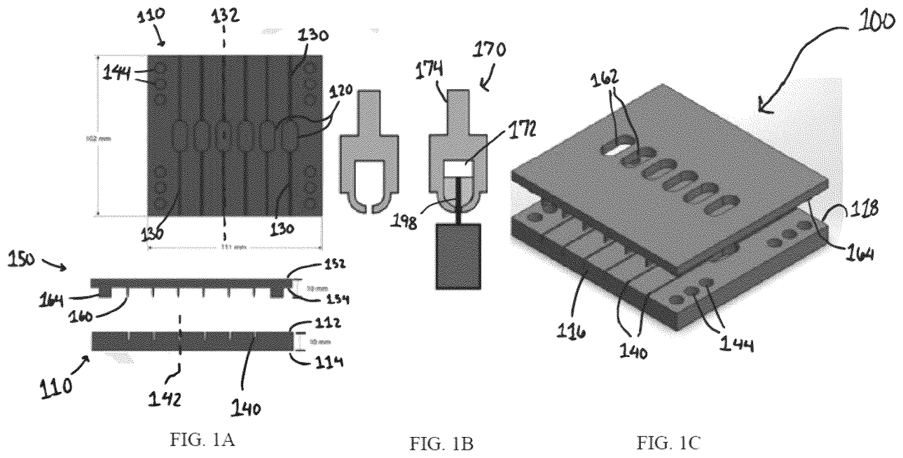

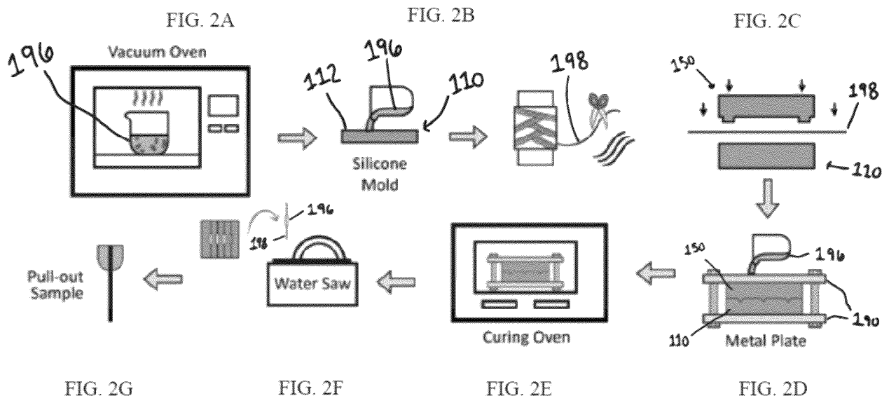

FIGS. 1A-2G show a mold 100 for forming composite samples for a pullout test, according to aspects of various embodiments described herein. In some implementations, as shown, the mold 100 includes a first body 110 and a second body 150.

The first body 110 has a first surface 112 and a second surface 114 spaced apart from the first surface 112. The first body 110 further has a first end surface 116 extending between the first surface 112 and the second surface 114 and a second end surface 118 spaced apart from the first end surface 116. The first surface of the first body 112 defines six slots 120 and twelve channels 130 each having a longitudinal axis.

Each of the six slots 120 are discorectangular shaped as viewed in a plane defined by the first surface 112. However, in other implementations, each of the slots can be any other closed shape as viewed in a plane defined by the first surface.

Two of the twelve channels 130 intersect each of the six slots 120 such that the longitudinal axes 132 of the two channels 130 intersecting the same slot 120 are collinear. Six of the channels 130 extend to the first end surface 116, and the other six channels 130 extend to the second end surface 118. The first end surface 116 and the second end surface 118 each define six grooves 140, each having a longitudinal axis 142. The longitudinal axis of each of the twelve channels 132 intersects a longitudinal axis 142 of a different one of the grooves 140.

The first surface of the first body 112 of the mold 100 shown in FIGS. 1A-2G defines six slots 120 and twelve channels 130, but in other implementations, the first surface of the first body defines any number of one or more slots and any number of one or more channels. In some implementations, the first surface of the first body defines one or three or more channels intersecting each slot. In some implementations, the channels intersecting one slot can be oriented in any way and their longitudinal axes are not collinearly aligned. In some implementations, the longitudinal axis of one or more channels intersecting one or more slots is parallel to the longitudinal axis of the respective one or more slots. In some implementations, one or more of the channels do not extend to the first end surface, the second end surface, or both.

The second body 150 has a first surface 152 and a second surface 154 spaced apart from the first surface of the second body 152. The second surface of the second body 154 defines twelve ridges 160, and each of the twelve ridges 160 is configured to be disposed within a separate one of the twelve channels 130 when the second surface of the second body 154 is disposed adjacent the first surface of the first body 112. In implementations in which the first surface of the first body includes any other number of channels, the second surface of the second body includes an equal number of ridges corresponding to the channels of the first body. In some implementations, the second surface of the second body does not include any ridges.

The second surface of the second body 154 further defines six polymer openings 162 extending to the first surface of the second body 152. The terms “resin,” “polymer,” and “epoxy” are used interchangeably herein. An example polymer can be EP37 or EP29. Each of the six polymer openings 162 is configured to be disposed adjacent to a separate one of the six slots 120 of the first body 110 when the second surface of the second body 154 is disposed adjacent the first surface of the first body 112. Thus, each of the six slots 120 is in fluid communication with a different one of the polymer openings 162 when the first body 110 and the second body 150 are combined.

Although the second surface of the second body 154 shown in FIGS. 1A-2G defines six polymer openings 162, in other implementations, the second surface of the second body includes any number of polymer openings in fluid communication with any number of slots of the first body when the first body and the second body are combined.

The first surface of the first body 112 defines twelve locator openings 144, and the second surface of the second body 154 defines twelve locator protrusions 164. Each of the twelve locator protrusions 164 are configured to be disposed within a different one of the twelve locator openings 144 when the second surface of the second body 154 is disposed adjacent the first surface of the first body 112. The locator openings 144 and locator protrusions 164 provide for alignment of the first body 110 relative to the second body 150 to ensure consistency in the composite samples formed by the mold, as discussed below.

Although the mold 100 shown in FIGS. 1A-2G includes twelve locator openings 144 and twelve locator protrusions 164, in some implementations, the mold includes any number of locator openings and locator protrusions. In FIGS. 1A-2G, the second body 150 includes the locator protrusions 164 and the first body 110 includes the locator openings 144, but in other implementations, the second body includes the locator openings, and the first body includes the locator protrusions. In some implementations, the first body and the second body include any other features configured to interact with each other to align the first body with the second body. In some implementations, the first body and the second body do not include any alignment features.

The first body 110 and the second body 150 shown in FIGS. 1A-2G are made of silicone, but in other implementations, the first body and/or the second body are made of any other suitable material for forming a composite sample or any combination of materials.

To form a composite sample for a pullout test using the mold 100 shown in FIGS. 2A-2G and described above, polymer 196 (e.g., epoxy, resin) is heated to a temperature below a reaction temperature of the polymer 196 to degas the polymer 196 and eliminate any bubbles existing therein, as shown in FIG. 2A. Once the bubbles are removed from the polymer 196, the polymer 196 is poured into each of the slots 120 defined by the first surface of the first body 112, as shown in FIG. 2B. A test material 198 (e.g., metal tape, stainless steel, steel, copper, aluminum, and/or the like) is then cut to size and placed within the channels 130 such that the test material 198 extends into the polymer 196 in the respective slots 120, as shown in FIG. 2C. Because the longitudinal axes of two channels 132 are collinearly aligned for each slot 120, the test material 198 can extend from one channel 130, through the slot 120, and into the collinearly aligned channel 130 on the other side of the slot 120. The ends of the test material 198 are then disposed within the grooves 140 that intersect the channels 130 to hold the test material 198 in place and in a straight/taut orientation.

The second body 150 is then lowered onto the first body 110 such that the first surface of the first body 112 abuts the second surface of the second body 154. In this configuration, each of the ridges 160 of the second body 150 extend into a different one of the channels 130 of the first body 110 to hold the test material 198 within the channels 130 in place. Because the channels 130 are V-shaped, the ridges 160 press the test material 198 into the tapered bottoms of the channels 130 to ensure that the test material(s) 198 are all positioned similarly to each other in each channel 130.

After the second surface of the second body 154 is disposed adjacent the first surface of the first body 112, compression plates 190 are applied to the first body 110 and the second body 150 to apply force to the first body 110 and the second body 150 to urge the first surface of the first body 112 toward the second surface of the second body 154, as shown in FIG. 2D. More polymer 196 is then poured through each of the polymer openings 162 of the second body 150 and into the slots 120 of the first body 110 to ensure that each of slots 120 is entirely filled.

The entire mold 100, including the compression plates 190, are then placed into a curing oven to cause the polymer 196 within the mold 100 to cure, as shown in FIG. 2E.

After the polymer 196 has cured, the cured polymer 196 is cut in half, perpendicular to the longitudinal axes of the channels 132, using a water saw or similar cutting device such that the polymer 196 is divided into two composite samples, as shown in FIG. 2F. Thus, each of the two composite samples includes a portion of test material 198 protruding from the portion of cured polymer 196, as shown in FIG. 2G.

To use the composite samples in a pullout test, the cured polymer composite sample is disposed within a fixture opening 172 defined by a testing fixture 170, as shown in FIG. 1B. As seen in FIG. 1B, the fixture opening 172 of the testing fixture 170 is a size and a shape to correspond with the size and shape of the cured polymer composite sample.

The testing fixture 170 also includes an attachment portion 174 that is couplable to a tensile testing machine. The composite sample is positioned in the fixture opening 172 such that the test material 198 extends out of the fixture opening 172 in a direction opposite of the attachment portion 174 of the tensile testing machine. The loose end of the test material 198 is then secured relative to the tensile testing machine such that force exerted by the tensile testing machine on the testing fixture 170 transfers the force to the composite sample in a direction parallel to the longitudinal axis of the test material 198. The tensile testing machine continues to apply an increasing amount of force to the composite sample until the connection of the cured polymer to the test material fails.

The horizontal mold concept is illustrated in FIG. 1A. Alumilite's Plat 55 silicone was used to create a stable mold for samples. The mold consists of racetrack-shaped slots with channels where the test materials are placed horizontally. Each slot produces two samples after cutting them in half after curing. The mold has grooves at the end of the channels to keep the test material in tension. A custom specimen fixture for holding the sample was designed to accommodate the sample's shape easily and to be able to test on a conventional tensile machine, as shown in FIG. 1B.

Subsequent steps were taken to prepare a polymer-metal composite. All polymers/epoxies are first heated below their reaction temperature. This process decreases the viscosity of the polymer/epoxy which is needed to mold the matrix. Once the specified viscosity was achieved, the polymer/epoxy began the degassing process to eliminate the bubbles after curing (FIG. 2A). Once no bubbles are observed in the polymer/epoxy, it is poured into preheated silicone molds before the metal material (e.g., metal tape) is placed (FIG. 2B). Then, the metal material is cut and placed within the silicon mold (FIG. 2C). The mold is enclosed with a silicone cover, then pressed under metal plates and refilled to complete the slot's volume (FIG. 2D). This setup is then placed in a curing oven with a standard curing cycle of the respective polymer/epoxy (FIG. 2E). Once the polymer/epoxy is cured, the samples are demolded from the silicon mold. To match the fixture used for the pullout test, each sample was cut in half using a water saw (FIG. 2F). If needed, the samples were polished from the flat surface to make a pullout sample with the required embedded length (FIG. 2G).

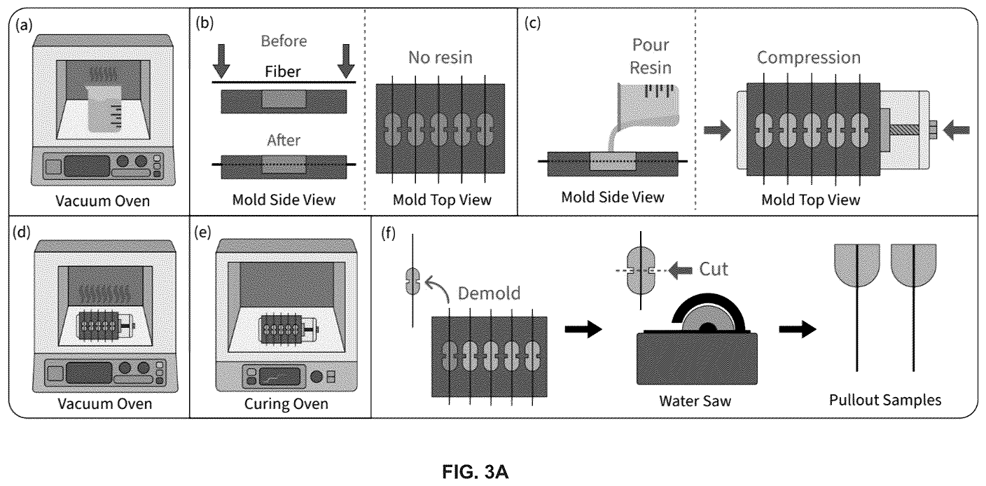

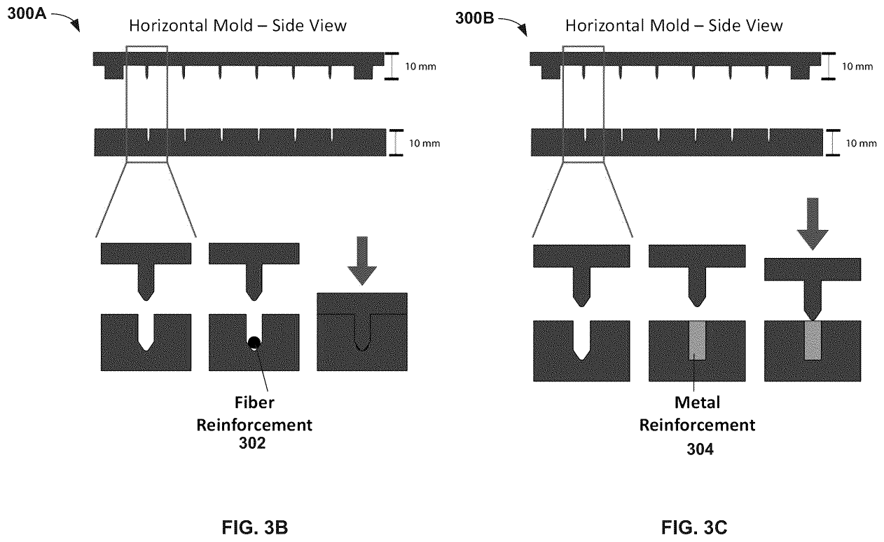

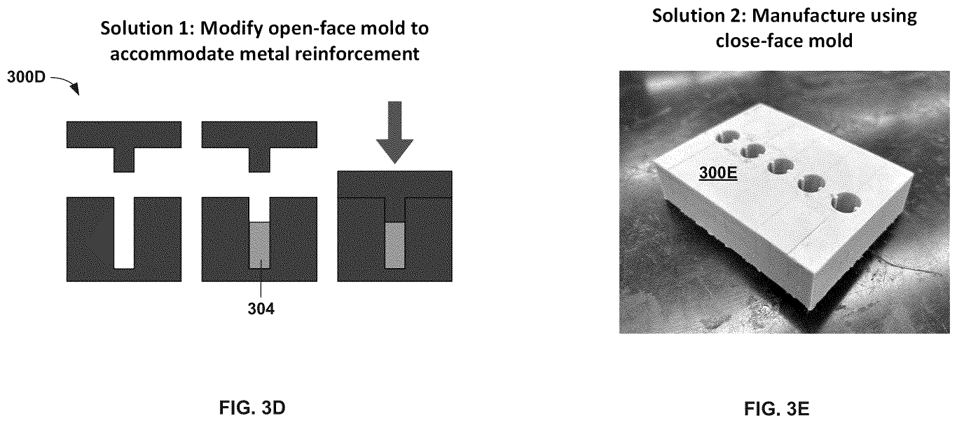

FIG. 3A shows an example method of manufacture in accordance with certain embodiments described herein. In various implementations, the example method can be used to prepare open-face and close-face molds. It should be understood that FIG. 3A may include at least a portion of the steps described above in relation to FIGS. 2A-2G.

Beginning at step (a), the manufacturing process starts by mixing a resin in a beaker, which is heated and degassed in a vacuum oven at a constant pressure and temperature until no bubbles are visible. At step (b), reinforcements are cut and placed within the horizontal silicone mold.

Referring now to FIG. 3B and FIG. 3C, side views of example horizontal molds (300A, 300B) comprising fiber reinforcement 302 and metal reinforcement 304, respectively, are shown.

Returning to FIG. 3A, at step (c), resin is poured into the mold. If an open-face mold is being used, the mold is enclosed with the silicone cover, then pressed under metal plates and refilled to complete the slot's volume. If a close-face mold is being used, compression perpendicular to the reinforcement's direction needs to be applied. FIG. 3D shows a modified open-face mold 300D configured to accommodate a metal reinforcement. FIG. 3E shows an example close-face mold 300E.

Returning to FIG. 3A, at step (d), the setup is placed into the vacuum oven to ensure complete degassing of the resin. At step (c), this setup is placed in a curing oven with the resin's standard curing cycle. Then, at step (f), the samples are removed from the mold and cut in half with a water saw at the resin's groove.

Subsequent to removing the samples (e.g., test material, pullout samples, composite samples, epoxy-metal samples) from the mold, a pullout test can be performed on the sample in a cryogenic environment (e.g., at a temperature between 77 K and 120 K) and one or more characteristics of the samples can be determined (e.g., via a testing instrument or at least one electronic circuit) during the pullout test. The pullout test can be a microbond test, FBPO, or SFPO.

### DISCUSSION

There has been an increased focus on the electrification of aircraft and ships to reduce carbon dioxide emissions [1], [2]. To make electric aircraft and ships a reality, one of the major technical limitations is developing an electrical power system with high power density, flexibility, and reliability [3], [4]. High temperature superconducting (HTS) power devices with high current density, and high specific power density are promising for large electric transport systems [5], [6], [7]. One of the challenges of HTS devices is the limited number of electrical insulation materials compatible with the cryogenic temperature operation of HTS devices [8]. Polyimide tape, epoxy resins, polypropylene laminated paper (PPLP), polytetrafluoroethylene (PTFE), Polyether ether ketone (PEEK), glass-reinforced epoxy (G10) are among the materials used for electrical insulation systems of HTS applications [8]. In addition to the usual stresses that exist in conventional power devices, electrical insulation in HTS power devices is subjected to large stresses due to the mismatch of thermal expansion coefficients of the insulation materials and the materials used for superconducting tapes/wires [9]. High ampacities and magnetic fields contribute to additional stresses from electromagnetic forces, and high energy radiation [10]. Fatigue of long-term cryogenic operation will also cause surface cracking, void formation, and delamination [8], [11]. Selection of suitable electrical insulation for cryogenic applications requires systematic investigations that include the electrical, mechanical, and thermal behavior of the insulation materials and systems.

Roebel assembled coated conductor (RACC), conductor on round core (CORC), and twisted stack cables of HTS materials have been developed and studied for different high current applications [12], [13], [14]. Small diameters and noncircular cross sections of the high current cable cause electric field enhancement on the surface of the conductor that needs to be considered [15]. The enhancement in the electric field could lead to partial discharge within the electrical insulation even at low voltages. Parametric studies identified that for voltages above 10 kV the required thickness of insulation increases significantly for small diameter HTS conductors compared to copper conductors of similar ampacity [15].

Polypropylene laminated paper (PPLP) impregnated with liquid nitrogen (LN2) has been used for HTS power cable applications due to its good electrical and thermal performance [16], [17]. The occurrence of PD within the butt gaps of PPLP lapped-tape insulation is the major limiting factor [18], [19], [20]. For HTS applications of electric aircraft and ships, gaseous helium (GHe) is the preferred cryogen instead of LN2 [21], [22], [23]. GHe has low dielectric strength leading to PD activity at significantly low voltages of <10 kV when lapped tape PPLP is used as electrical insulation [24]. NASA and other agencies have announced aggressive targets for power density for the next generation of electric aircraft and ships expected to operate at or below 20 kV. For safe operation at that voltage, the electrical insulating systems must be capable of withstanding up to 41 kV [25]. Recent studies have focused on the requirements of electrical insulation materials for electric aviation applications that include resistance to surface tracking and degradation under multi-stress aging, absence of PD at low voltages, and excellent thermal and mechanical stress tolerance at cryogenic temperatures [8], [25]. Some argue that HTS enable applications at low voltage because of their ability to support high ampacity. To support the expected 20-40 MW aircraft [26], and 100 MW ships [4], even with several kA current, the power system will need to operate at several kV. A second reason is the limitation of the challenge of the power electronic drives and switchgear supporting several kA. Hence, even when using HTS devices capable of supporting kA ampacity, the power systems will need a voltage of several kV. System-level optimization of the voltage and current tradeoffs to achieve the required efficiency, power density, reliability, and safety targets will inform the appropriate ratings.

Stycast, Araldite, and ER2220 epoxy resins have been used for electrical insulation for cryogenic applications. Though epoxy resins have excellent electrical, thermal, and mechanical properties they are not flexible and have thermal expansion coefficients significantly different from metals at cryogenic temperatures [27], [28]. The disparities in the thermal expansion coefficients cause delamination, mechanical damage, and a reduction in current carrying capacity [27], [28]. New epoxy adhesives are being developed with high thermal conductivity, compatibility with cryogenic temperatures, shock resistance, and low outgassing requirements for space application [29]. The study reported here discusses the experimental investigations of the electrical, thermal, and mechanical performance of two commercial epoxies relevant to HTS power device applications. It is beneficial to have commercial epoxies if they are suitable because of the consistency in composition and quality rather than making custom epoxies that are difficult to maintain quality from batch to batch. By way of example, extruded cable is typically not compatible to cryogenic temperatures and cryogenic epoxies may provide similar or better performance at cryogenic temperatures. However, cryogenic epoxies must be impervious to cracking and/or delamination at cryogenic temperatures and will therefore require measurement tools and protocols to verify performance that are not presently available.

### EXPERIMENTAL RESULTS AND EXAMPLES

A study was conducted to develop measurement tools and protocols, for example, for shear strength measurements of cryogenic epoxy interfaces. The two commercial epoxies explored in the study are rated for cryogenic temperatures and the study evaluated them for electrical insulation systems. Two commercial cryogenic rated epoxies, Masterbond EP29-LPSP and EP37-3 FLFAO, were evaluated to explore their suitability for electrical insulation systems of HTS power devices such as cables. Electrical breakdown and mechanical characterization of the epoxy coupons and HTS tape samples coated with the epoxies were reported at room temperature and 77 K. The results of the first stage of the ongoing study show the promise of the two materials for electrical insulation systems of HTS power devices for emerging electric transport systems such as aircraft and ships. The promising results led us to plan enhancements to the experimental apparatus for continuing the studies on prototype HTS cables at 77 K to further the qualification of the epoxies for commercial applications.

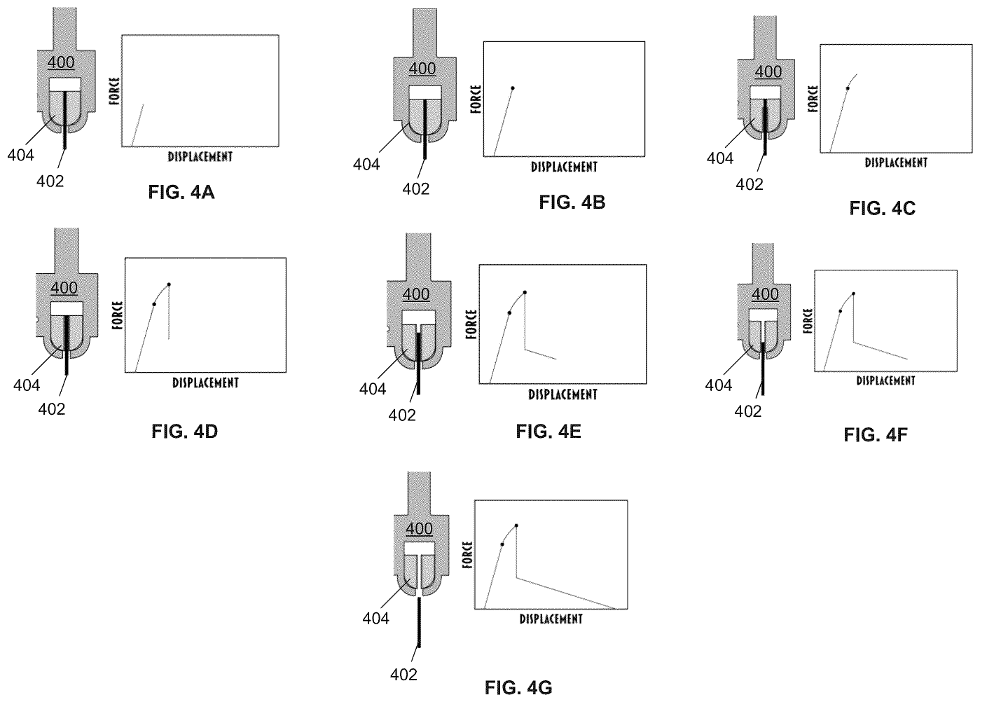

FIGS. 4A-4G is a series of images illustrating an example pullout test in a custom mechanical fixture 400 with graphs showing corresponding force-displacement values. As depicted, the pullout test is employed to test a bonding strength (e.g., IFSS test) between a metal material 402 (e.g., HTS tape) and epoxy 404, which together form the testing material. During testing, the metal material 402 is debonded from the epoxy 404 and the force/displacement during debonding is measured as illustrated in the corresponding graphs in each of FIGS. 4A-4G.

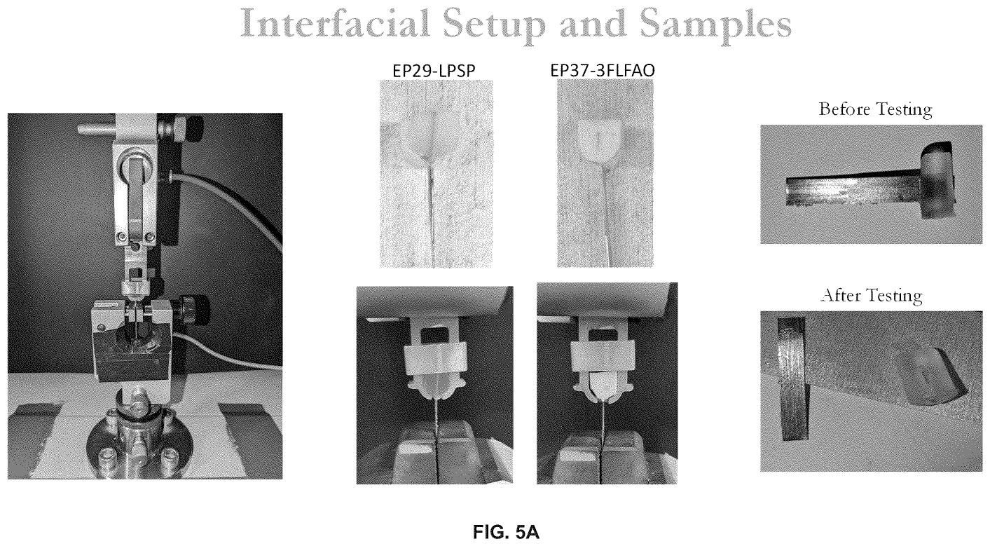

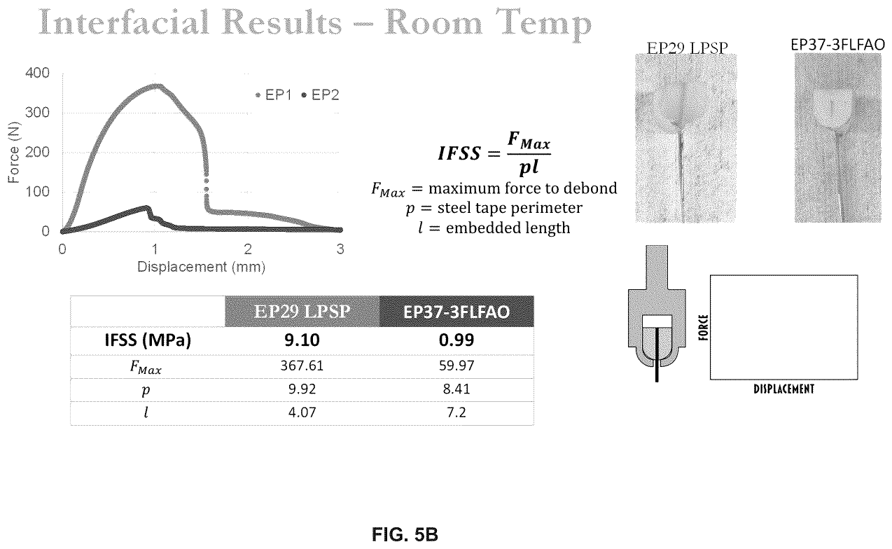

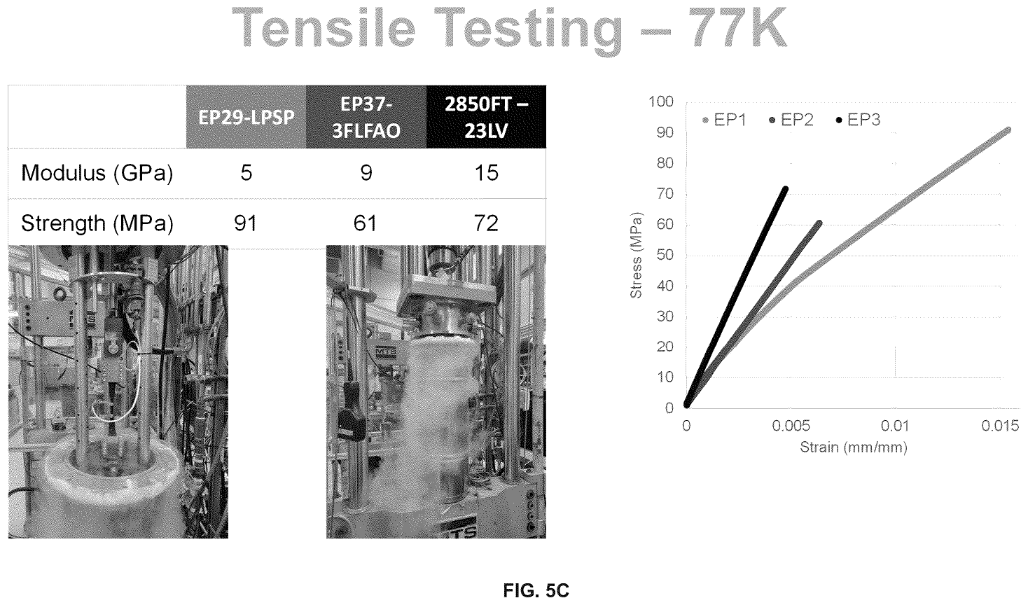

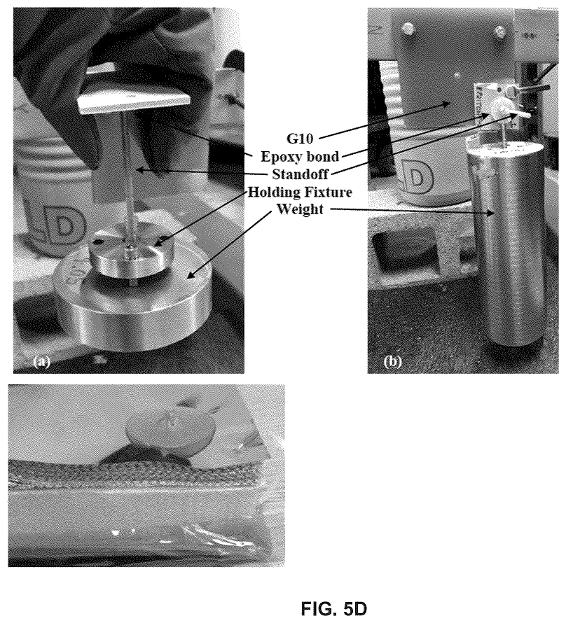

FIG. 5A-5D show experimental results from the conducted study. FIG. 5A shows an interfacial setup and samples. Two different epoxies, EP29-LPSP and EP37-3FLFAO, were tested. These materials were selected due to mechanical flexibility at room temperature for HTS power cables. During testing, each epoxy was debonded from HTS tape (American superconductor 2nd generation HTS tape-4 mm with 0.2 mm thickness, stainless steel stabilizer layers—100 A at 77 k) and the force/displacement during debonding was measured. As shown in the graph, the higher the maximum force to debond (Fₘₐₓ), the better the bond between the given epoxy and metal interface. FIG. 5B shows results from interfacial testing results of the epoxies depicted in FIG. 5A. FIG. 5C shows results from tensile testing of the epoxies depicted in FIG. 5A. The tensile testing results greatly exceeded the values recorded in the manufacturer's specification sheets. FIG. 5D are images illustrating adhesion of a blanket stand to cryogenic tanks for testing. Measurements were completed at 86 K in both tensile and shear configurations. An epoxy encapsulant, 2850 FT, was used to adhere a commercial Multilayer Insulation (MLI) blanket stand to a 0.25″ Aluminum 6061. The 2850 FT showed promising results from initial measurements and can be cured at room temperature.

### Epoxy Insulation for HTS Power Applications

The EP29-LPSP and EP37-3FLFAO epoxies manufactured by MASTERBOND were used in the present study. In the following text, the two epoxies were referred to as EP1 (EP29-LPSP) and EP2 (EP37-3FLFAO), respectively. Both epoxies were two-part (epoxy resin and curing agent) systems with a mixing ratio of one to one by weight or volume. The primary reason for selecting the epoxies for the study was their compatibility with cryogenic temperatures down to 4 K while displaying mechanical flexibility at room temperature [29]. The electrical insulation characteristics, mechanical compatibility for HTS materials, and mechanical strength necessary for the use as part of electrical insulation systems of HTS power devices have not been reported. The formation of voids or cracks during the coating of epoxies on HTS significantly alters the electrical insulation performance. Hence, a procedure to eliminate or minimize void or crack formation has been adopted for preparing the specimens. The required quantity of epoxy resin and curing agent were mixed thoroughly in a dry container and the mixture was degassed using a planetary centrifugal mixer at 2000 rpm for 3 minutes. The mixture was poured into a predesigned silicone mold and cured at 80° C. for 8 hours in a temperature-controlled oven followed by curing at room temperature for 24 hours. Different size samples were prepared depending on the measurement conducted. Flat specimens of EP1 and EP2 with thicknesses between 1.5-1.9 mm were used for dielectric breakdown measurements at room temperature in transformer oil and 77 K in LN2. To understand the impact of epoxy coating on the critical current of HTS tapes, 0.5 mm uniform coating was applied to the HTS tapes. To understand the influence of the interface between the epoxy and HTS materials in the applications, EP1 and EP2 were applied to short sections of HTS tapes and the interfacial shear strength was measured. Both EP1 and EP2 samples were fabricated in the required shape for the dynamic mechanical analysis (DMA).

### The Influence of the Epoxy Insulation Coating on IC

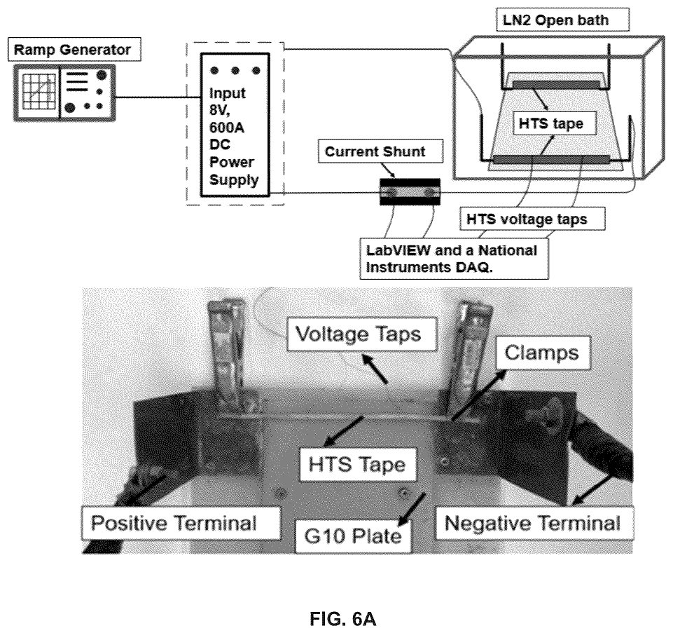

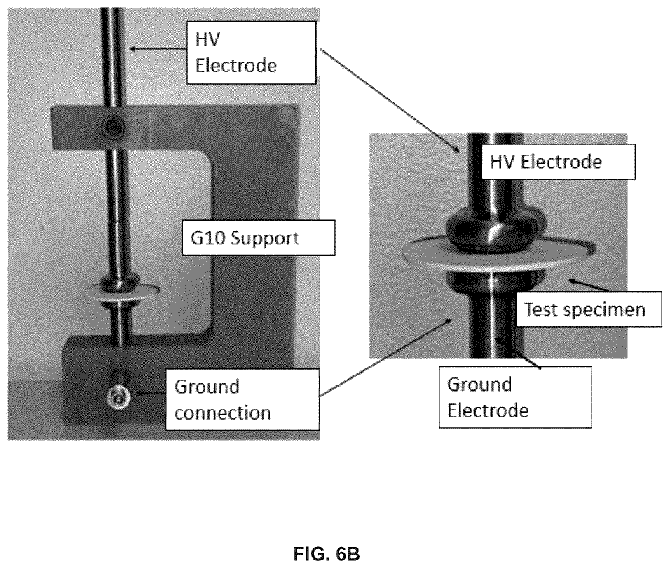

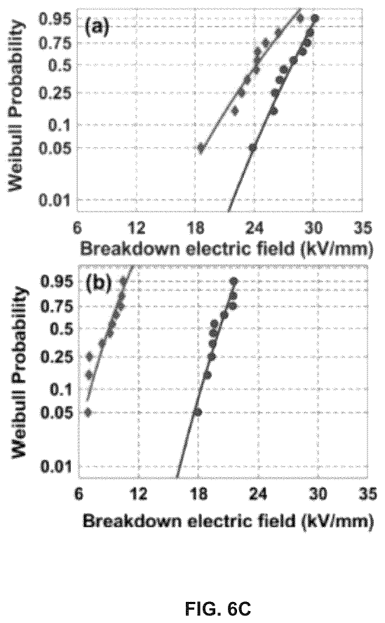

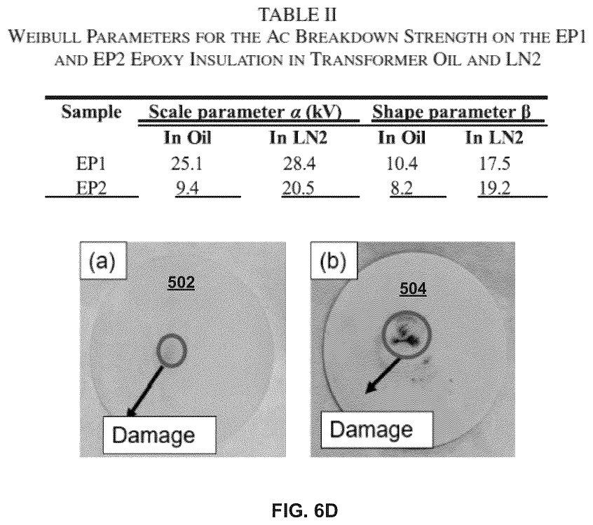

Epoxy impregnation of HTS coils and cables causes mechanical stresses leading to delamination and degradation [27], [28]. The disparity in the coefficients of thermal expansion (CTE) of the materials during the thermal cycles leads to stresses. It has been reported that the stress due to epoxy impregnation causes delamination and critical current (Ic) deterioration [30], [31], [32], [33]. Techniques have been developed to mitigate the CTE mismatch and minimize the deterioration of Ic [34]. This section discusses the influence of the two epoxy insulation coatings on the Ic of HTS tapes. FIG. 6A shows the experimental setup used for Ic measurements. The four-terminal approach and the electric field criterion of 1 μV/cm were used for Ic at 77K in an LN2 bath. Each sample was measured at least three times with the average of the results being recorded in Table I. A G10 plate assembly with thick ‘L’ shaped Cu metal leads served as the sample holder. A 600 A, GENESYSTM DC power supply controlled by a ramp generator was used as the current source and provided a ramp rate of 12 V/s. The HTS tapes were placed horizontally and connected to the Cu terminals using pony stainless steel clamps. During Ic measurements, it was made sure that the HTS tape was completely submerged in LN2. Using the electric field criterion and a gap distance of #cm between the voltage taps, the Ic was determined to be the current flowing through the tape when #V or more was measured between the taps. The voltage was measured using the voltage taps on the HTS tape. The current was measured using a standard shunt. The voltages across the sample and the shunt were acquired using LabVIEW and a National Instruments data acquisition system (DAQ) with a resolution of 0.1 μV. The recommended process required accelerated curing at 80° C. for 8 hours followed by 24 hours at room temperature. Ic measurements were conducted on control samples after heating at 80° C. for 8 hours (without the epoxy coatings, referred to as baked) and the completely processed epoxy coated, cured tapes. Table I shows the measured Ic values of two different HTS tapes for the three different conditions discussed above. The heating of the HTS tapes at 80° C. for 8 hours lowered HTS tape Ic marginally except for one sample.

Table I shows slight reductions in Ic for EP1 and EP2 coatings. The reduction in Ic was smaller for EP2 samples compared to the EP1 samples. It was noticed that samples coated with EP1 were harder to remove from the silicone molds compared to those of EP2. The additional handling needed for EP1 samples could be the reason for the lower Ic values. In HTS applications, cables or HTS tape bundles are used to achieve the required kA level Ic [35]. HTS cables and tape bundles will have greater resiliency for mechanical damage compared to a single HTS tape. Given the results in Table I, a future direction of the work would be to coat HTS prototype cables and study their characteristics.

TABLE I
Critical Current Ic (A)

| Control Ic | Baked at 80° C. | Coated with EP1 | Coated with EP2 |
|---|---|---|---|
| 94.9 | 94.2 | 77.2 | — |
| 97.1 | 83.3 | 69.8 | — |
| 96.6 | 92.5 | 70.7 | — |
| 91.6 | 90.2 | — | 89.8 |
| 96.3 | 92.7 | — | 85.2 |
| 91.3 | 90.1 | — | 84.2 |

### Dielectric Breakdown Measurements

Dielectric breakdown strength measurements of samples of the two epoxies, EP1 and EP2, were conducted at 77 K in a LN2 bath. For comparison purposes, the dielectric breakdown strength was also evaluated at room temperature in transformer oil. FIG. 6B shows the electrode arrangement used for the breakdown measurements. Electrodes made of stainless steel that have a Bruce electric profile with a diameter of 25.1 mm were used [36]. They were mounted vertically on a G10 assembly. Before each measurement, the electrodes were polished and cleaned with isopropyl alcohol. During the measurements, care was taken to avoid scratching or introducing other contaminants to the electrode surfaces. The electrodes were replaced after every two measurements. Specimens of EP1 and EP2 with thicknesses of 1.5 mm and 1.9 mm were used for the measurements. AC voltage at 60 Hz was generated using a 100 kV, 100 kVA discharge-free testing transformer. The voltage was increased at 300 V/s until a breakdown occurred. For measuring dielectric breakdown strength at room temperature, the epoxy sample was placed between the electrodes and submerged in a transformer oil (mineral oil) bath in an acrylic container. For the measurements at 77 K, the epoxy sample was placed between the electrodes, and the assembly was immersed in an open LN2 bath. FIG. 6C shows the Weibull probability plots of the breakdown electric field for EP1 and EP2 specimens at room temperature and 77 K. A set of ten breakdown measurements was conducted for each sample.

For both the epoxy types the breakdown strength is higher at 77 K compared to that at room temperature. For EP1 and EP2 the mean breakdown strength is higher by 17% and 120%, respectively at 77 K compared to the values at room temperature. Further, EP1 has higher breakdown strength compared to EP2 both at room temperature and 77 K. The maximum breakdown strength of EP2 at room temperature was 63% lower than the minimum breakdown strength at LN2. The results of the dielectric strength measurements obtained in this study demonstrate that EP1 performs better than EP2. Further work is needed to further characterize the dielectric and discharge behavior of these epoxies and their effects in high power cable applications. The scaling parameter (a) and shape factor obtained from the dielectric breakdown strength Weibull probability analysis at room temperature and 77 K are listed in Table II (FIG. 6D). The results show that both the epoxy systems have higher dielectric strength at 77 K and EP1 has superior performance.

FIG. 6D shows the visual damage to the samples caused by the breakdown events in EP1 (502) and EP2 (504) samples. Both the epoxy specimens showed almost no physical damage from the breakdowns at 77 K. However, the room temperature breakdown measurements caused slight damage to the EP1 specimens and a significant puncture through the EP2 specimens. Given the samples tolerated the measurements at 77 K in LN2 without cracking or failing shows promise of their suitability as electrical insulation for HTS power devices. The sample thickness of 1.5-1.9 mm was intentionally chosen to match the required thickness of typical HTS devices, for example, HTS cables rated for 10 kV operation [37].

### Characterization of Interface Between HTS Tape and the Epoxy

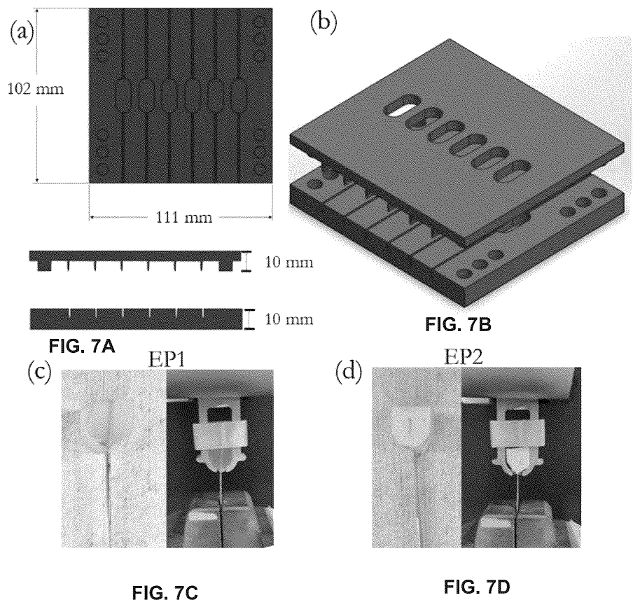

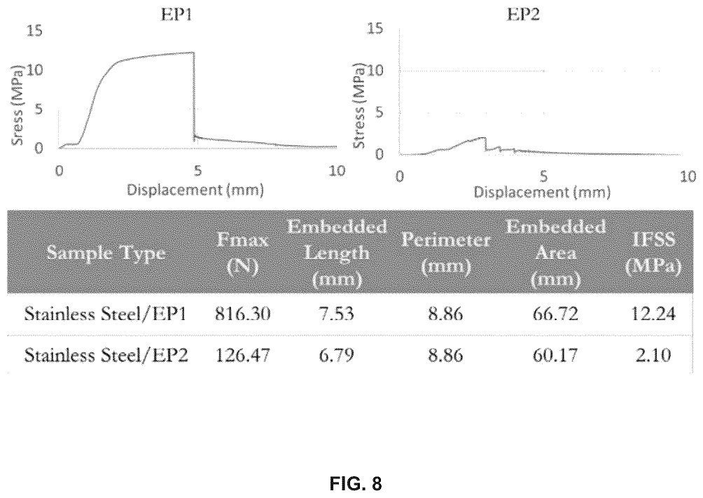

Mechanical bonding between the HTS tape and the epoxy affects the delamination problem reported [27], [28]. Delamination between the layers of the HTS conductor or between the HTS tape and the epoxy will cause void formation that results in a large electric field enhancement leading to partial discharge. The occurrence of partial discharge limits the operating voltage and the lifetime of the HTS device. Interfacial shear strength (IFSS) measurements were performed at room temperature to assess the bonding of the epoxies to the HTS tape. The IFSS of composite materials is the threshold where cracking and separation occur in a shear-loading scenario. The IFSS is measured using a pullout method [38], where the HTS tape is the reinforcement, and the epoxy is cast around the HTS tape for pullout test samples. A custom molding process used to cast the pullout specimens is shown in FIGS. 7A-7D. The fixture and sample were placed in a Shimadzu AGS-X mechanical testing frame with the fixture gripped at the top, the sample resting in the un-clamped cradle of the fixture, and the bottom clamp secured to the HTS tape as shown in FIG. 7C. The tests were performed at room temperature. The HTS tape/epoxy samples are shown in FIG. 7C, both in and out of the custom fixture and the mechanical frame for testing. The pullout stress/displacement curves and resultant IFSS are depicted in FIG. 8. The peak stress in the graphs is the IFSS, and the portion after the peak is the frictional sliding zone. The EP1 showed a much greater shear bonding strength with the HTS tape than the EP2. This suggests a higher bonding strength that might be due to the higher modulus of the EP1.

As part of our continued investigation of these epoxies, enhancements for the apparatus are underway for future measurements of the IFSS of the HTS tape/epoxy at cryogenic temperature. Performing these measurements at 77 K will give greater insight into the feasibility of the epoxies as electrical insulation for HTS devices that operate at 77 K.

### Dynamic Mechanical Analysis

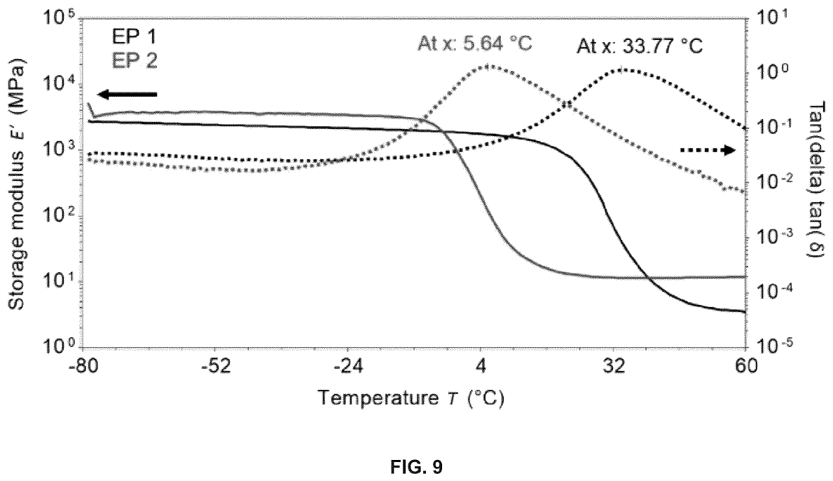

The polymer glass transition temperature obtained by dynamic mechanical analysis (DMA) is used to assess the thermomechanical transitions, shown as the glass transition temperature (Tg) of the epoxies. DMA was performed using a TA Instruments ARES-G2 in tension from −80 to 60° C. FIG. 9 shows the results of the DMA of EP1 and EP2. EP1 showed a lower modulus with a Tg of 33.8° C., while EP2 demonstrated a higher modulus at lower temperatures with a Tg of 5.6° C. Around room temperature, the EP1 is still below the glass transition temperature and is stiffer than the rubbery EP2.

Characterizing the DMA of both epoxies provided insight into their mechanical flexibility at room temperature. HTS cables require mechanical flexibility to enable wrapping the cable spool on a drum for transportation and installation. The minimum bend radius of the HTS cable is specified based on the cryostat used for the cable installation. The DMA results show that both EP1 and EP2 possess the required reduction in modulus that allows for increased strain tolerance needed for HTS cable applications.

### DISCUSSION

Manufacturing and testing of pullout samples, dielectric measurements, and flexibility demonstrated through DMA that both EP1 and EP2 show promise as electrical insulation materials for HTS power applications. The ability to apply a uniform epoxy coating onto an HTS conductor would benefit in reducing the complexity and uncertainty of electrical insulation of HTS devices. Factory acceptance tests cannot be performed prior to the installation of HTS cables due to the need for cryogen, such as LN2 being a part of the composite dielectric insulation system. Utilizing the epoxies as the electrical insulation material would enable factory acceptance tests of HTS cables prior to installation, improving confidence and promoting the commercial prospects of HTS devices in emerging applications such as electric transport systems. The higher modulus of EP1 dramatically contributes to an increased interfacial shear strength between the EP1 epoxy and HTS conductor. The relationship between epoxy stiffness and bonding at varied temperatures is useful in the design and design material selection of electrical insulation systems.

The promising dielectric strength results of both EP1 and EP2 at 77 K encouraged us to continue the investigations for HTS cable electrical insulation. We have begun to develop 1 m long prototype HTS cables using both EP1 and EP2. Partial discharge inception voltage (PDIV) measurements in various media at 77 K have been conducted. The measurements show great promise as no degradation of PDIV after several thermal cycles. The degradation of PDIV would be an indication of delamination between the conductor and insulation. The results obtained also demonstrate the potential to install the HTS cable within a metallic former with an epoxy coating, a potential technique to alleviate the risk of Ic degradation shown in Table I. We plan to continue further mechanical characterization of EP1 and EP2, including IFSS and tensile tests at 77 K.

### CONCLUSION

Two commercial cryogenic rated epoxies, Masterbond EP29-LPSP and EP37-3 FLFAO, were evaluated to explore their suitability for electrical insulation systems of HTS power devices such as cables. Electrical breakdown and mechanical characterization of the epoxy coupons and HTS tape samples coated with the epoxies were reported at room temperature and 77 K. The results of the first stage of the ongoing study show the promise of the two materials for electrical insulation systems of HTS power devices for emerging electric transport systems such as aircraft and ships. The promising results led us to plan enhancements to the experimental apparatus for continuing the studies on prototype HTS cables at 77 K to further the qualification of the epoxies for commercial applications.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

The following patents, applications, and publications, as listed below and throughout this document, are hereby incorporated by reference in their entireties herein.
[1] M. Sharmina et al., “Decarbonising the critical sectors of aviation, shipping, road freight and industry to limit warming to 1.5-2° C.,” Climate Policy, vol. 21, no. 4, pp. 455-474, 2021, doi: 10.1080/14693062.2020.1831430.
[2] P. J. Ansell and K. S. Haran, “Electrified airplanes: A path to zero-emission air travel,” IEEE Electrific. Mag., vol. 8, no. 2, pp. 18-26, June 2020, doi: 0.1109/MELE.2020.2985482.
[3] Commercial Aircraft Propulsion and Energy Systems Research: Reducing Global Carbon Emissions. Washington, DC, USA: National Academies Press, 2016, doi: 10.17226/23490.
[4] “Naval power systems technology development roadmap PMS 320,” April 2013. Accessed: Sep. 27, 2022. [Online]. Available: https://defenseinnovationmarketplace.dtic.mil/wp-content/uploads/2018/02/NavalPowerSystemsTechnologyRoadmap.pdf
[5] P. Cheetham et al., “High temperature superconducting power cables for MVDC power systems of navy ships,” in Proc. IEEE Electric Ship Technol. Symp., 2019, pp. 548-555, doi: 10.1109/ESTS.2019.8847830.
[6] C. A. Luongo et al., “Next generation more-electric aircraft: A potential application for HTS superconductors,” IEEE Trans. Appl. Supercond., vol. 19, no. 3, pp. 1055-168 June 2009, doi: 10.1109/TASC.2009.2019021.
[7] “Airbus reveals new zero-emission concept aircraft,” September 2020. [Online]. Available: https://www.airbus.com/en/newsroom/press-releases/2020-09-airbus-reveals-new-zero-emission-concept-aircraft2035
[8] M. Yazdani-Asrami, S. M. Seyyedbarzegar, M. Zhang, and W. Yuan, “Insulation materials and systems for superconducting powertrain devices in future cryo-electrified aircraft: Part I-Material challenges and specifications, and device-level application,” IEEE Elect. Insul. Mag., vol. 38, no. 2, pp. 23-36, March/April 2022, doi: 10.1109/MEI.2022.9716211.
[9] S. Pamidi, C. H. Kim, and L. Graber, “High-temperature superconducting (HTS) power cables cooled by helium gas,” in Superconductors in the Power Grid, New York, NY, USA: Elsevier, 2015, pp. 225-260, doi: 10.1016/B978-1-78242-029-3.00007-8.
[10] M. Hara and H. Okubo, “Electrical insulation characteristics of superconducting power apparatus,” Cryogenics, vol. 38, no. 11, pp. 1083-193 November 1998, doi: 10.1016/S0011-2275 (98) 00095-2.
[11] H. Rajainmaki, D. Evans, J. Knaster, and M. Losasso, “The electrical insulation of large superconducting magnets,” IEEE Trans. Appl. Supercond., vol. 23, no. 3, June 2013, Art. no. 3800505, doi: 10.1109/TASC.2013.2240037.
[12] E. Pardo, M. Staines, Z. Jiang, and N. Glasson, “AC loss modelling and measurement of superconducting transformers with coated-conductor Roebel-cable in low-voltage winding,” Supercond. Sci. Technol., vol. 28, no. 11, October 2015, Art. no. 114008, doi: 10.1088/0953-2048/28/11/114008.
[13] J. Goo, J. W. Han, S. Lee, W. S. Kim, K. Choi, and J. K. Lee, “Magnetization loss of CORC with various configurations of 2G HTS strands,” IEEE Trans. Appl. Supercond., vol. 31, no. 5, August 2021, Art. no. 5901205, doi: 10.1109/TASC.2021.3067810.
[14] Z. Zhu, Y. Wang, S. Venuturumilli, J. Sheng, M. Zhang, and W. Yuan, “Influence of harmonic current on magnetization loss of a triaxial CORC REBCO cable for hybrid electric aircraft,” IEEE Trans. Appl. Supercond., vol. 28, no. 4, June 2018, Art. no. 5900405, doi: 10.1109/TASC.2018.2813001.
[15] T. Stamm, P. Cheetham, C. H. Kim, and S. V. Pamidi, “Superconducting power cable design with hybrid cryogenic media-gaseous helium for cooling and liquid nitrogen for dielectric insulation,” in Proc. IEEE Elect. Insul. Conf., 2020, pp. 22-26, doi: 10.1109/EIC47619.2020.9158651.
[16] C. Peng et al., “Insulation characteristics of dielectric material for CD HTS cable,” IEEE Trans. Appl. Supercond., vol. 29, no. 2, March 2019, Art. no. 7700405, doi: 10.1109/TASC.2018.2885780.
[17] W. J. Kim, S. H. Kim, H. J. Kim, J. W. Cho, J. S. Lee, and H. G. Lee, “The fundamental characteristics of PPLP as insulating material for HTS DC cable,” IEEE Trans. Appl. Supercond., vol. 23, no. 3, June 2013, Art. no. 5401704, doi: 10.1109/TASC.2013.2244158.
[18] H. Okubo, H. Kojima, F. Endo, K. Sahara, R. Yamaguchi, and N. Hayakawa, “Partial discharge activity in electrical insulation for high temperature superconducting (HTS) cables,” IEEE Trans. Dielectrics Elect. Insul., vol. 15, no. 3, pp. 647-654, June 2008.
[19] P. G. Cheetham, W. Kim, C. H. Kim, S. V. Pamidi, L. Graber, and H. Rodrigo, “Use of partial discharge inception voltage measurements to design a gaseous helium cooled high temperature superconducting power cable,” IEEE Trans. Dielectrics Elect. Insul., vol. 24, no. 1, pp. 191-199, February 2017, doi: 10.1109/TDEI.2016.005909.
[20] N. Hayakawa et al., “Dielectric characteristics of HTS cables based on partial discharge measurement,” IEEE Trans. Appl. Supercond., vol. 15, no. 2, pp. 1802-185 June 2005, doi: 10.1109/TASC.2005.849292.
[21] P. Cheetham, C. Park, C. H. Kim, L. Graber, and S. V. Pamidi, “Dielectric properties of cryogenic gas mixtures for superconducting power applications,” IOP Conf. Ser.: Mater. Sci. Eng., vol. 278, no. 1, December 2017, Art. no. 012040, doi: 10.1088/1757-899X/278/1/012040.
[22] A. Al-Taie et al., “Understanding surface flashover strength in cryogenic helium gas for superconducting devices,” IEEE Trans. Appl. Supercond., vol. 29, no. 5, August 2019, Art. no. 7701805, doi: 10.1109/TASC.2019.2905953.
[23] P. Cheetham, C. Kim, L. Graber, and S. Pamidi, “Implementation of superconducting cables in medium voltage DC integrated power systems on all electric ships,” in Proc. IEEE 44th Annu. Conf. Ind. Electron. Soc., 2018, pp. 3425-3430.
[24] P. G. Cheetham, W. Kim, C. H. Kim, S. V. Pamidi, L. Graber, and H. Rodrigo, “Use of partial discharge inception voltage measurements to design a gaseous helium cooled high temperature superconducting power cable,” IEEE Trans. Dielectrics Elect. Insul., vol. 24, no. 1, pp. 191-199, February 2017, doi: 10.1109/TDEI.2016.005909.
[25] M. Borghei and M. Ghassemi, “Insulation materials and systems for more- and all-electric aircraft: A review identifying challenges and future research needs,” IEEE Trans. Transp. Electrific., vol. 7, no. 3, pp. 1930-1953 September 2021, doi: 10.1109/TTE.2021.3050269.
[26] H. Xu, R. Lowndes, and I. Cotton, “Power capacity of high voltage cables for future electrical aircraft,” in Proc. IEEE Elect. Insul. Conf., 2021, pp. 177-180, doi: 10.1109/EIC49891.2021.9612313.
[27] T. Matsuda et al., “Degradation of the performance of an epoxy impregnated REBCO solenoid due to electromagnetic forces,” Cryogenics, vol. 90, pp. 47-51, March 2018, doi: 10.1016/j.cryogenics.2018.01.002.
[28] T. Takematsu et al., “Degradation of the performance of a YBCO-coated conductor double pancake coil due to epoxy impregnation,” Physica C: Supercond. Appl., vol. 470, no. 17-18, pp. 674-677, September 2010, doi: 10.1016/j.physc.2010.06.009.
[29] “Epoxy adhesives for cryogenic applications.” [Online]. Available: https://www.masterbond.com/properties/epoxy-adhesives-cryogenicapplications
[30] S. Yazaki, A. Karasawa, T. Kotoyori, A. Ishiyama, and N. Miyahara, “Critical current degradation in high-temperature superconducting tapes caused by temperature rise,” IEEE Trans. Appl. Supercond., vol. 23, no. 3, June 2013, Art. no. 4602404, doi: 10.1109/tasc.2013.2244157.
[31] Z. Yang, Y. Li, P. Song, M. Guan, F. Feng, and T. Qu, “Effect of edge cracks on critical current degradation in REBCO tapes under tensile stress,” Superconductivity, vol. 1, March 2022, Art. no. 100007, doi: 10.1016/j.supcon.2022.100007.
[32] P. Gao et al., “Effect of resin impregnation on the transverse pressure dependence of the critical current in ReBCO Roebel cables,” Supercond. Sci. Technol., vol. 32, no. 5, April 2019, Art. no. 055006, doi: 10.1088/1361-6668/ab08bd.
[33] C. Guo et al., “Synergic realization of electrical insulation and mechanical strength in liquid nitrogen for high-temperature superconducting tapes with ultra-thin acrylic resin coating,” Supercond. Sci. Technol., vol. 35, no. 7, July 2022, Art. no. 075014, doi: 10.1088/1361-6668/ac6e0d.
[34] C. Barth, N. Bagrets, K. P. Weiss, C. M. Bayer, and T. Bast, “Degradation free epoxy impregnation of REBCO coils and cables,” Supercond. Sci. Technol., vol. 26, no. 5, May 2013, Art. no. 055007, doi: 10.1088/0953-2048/26/5/055007.
[35] K. S. Haran et al., “High power density superconducting rotating machines-Development status and technology roadmap,” Supercond. Sci. Technol., vol. 30, no. 12, November 2017, Art. no. 123002, doi: 10.1088/1361-6668/aa833e.
[36] H. Rodrigo, D. Kwag, L. Graber, B. Trociewitz, and S. Pamidi, “AC flashover voltages along epoxy surfaces in gaseous helium compared to liquid nitrogen and transformer oil,” IEEE Trans. Appl. Supercond., vol. 24, no. 3, June 2014, Art. no. 7700506, doi: 10.1109/TASC.2013.2286744.
[37] W. Pi et al., “Insulation design and simulation for three-phase concentric high-temperature superconducting cable under 10-kV power system,” IEEE Trans. Appl. Supercond., vol. 29, no. 2, March 2019, Art. no. 7700104, doi: 10.1109/TASC.2018.2883148.
[38] A. de Leon, M. Tank, and R. Sweat, “A scalable fiber bundle pullout manufacturing method for data-driven interfacial shear strength measurements of micro and nanomaterials,” Composites Sci. Technol., vol. 222, May 2022, Art. no. 109375, doi: 10.1016/j.compscitech.2022.109375.

What is claimed is:

1. A mold for forming composite samples for a pullout test for high temperature superconducting (HTS) devices suitable for cryogenic temperatures, the mold comprising:
a body having a first surface and a second surface spaced apart from the first surface,
wherein the first surface defines one or more slots and one or more channels,
wherein each of the one or more channels has a longitudinal axis, and
wherein at least one of the channels intersects one of the slots.

2. The mold of claim 1, wherein the composite samples comprise metal material and polymer.

3. The mold of claim 1, wherein at least one channel intersecting the one or more slots comprises two channels.

4. The mold of claim 3, wherein longitudinal axes of the two channels are collinear.

5. The mold of claim 1, wherein the body has an end surface extending between the first surface and the second surface, wherein at least one of the channels extends to the end surface.

6. The mold of claim 5, wherein the end surface defines at least one groove having a longitudinal axis, wherein the longitudinal axis of at least one channel intersects the longitudinal axis of the at least one groove.

7. The mold of claim 1, wherein each of the one or more slots are discorectangular shaped as viewed in a plane defined by the first surface.

8. The mold of claim 1, wherein each of the one or more slots has a longitudinal axis and the longitudinal axis of at least one of the channels intersecting the one or more slots is parallel to the longitudinal axis of the one or more slots.

9. The mold of claim 8, wherein the longitudinal axis of at least one of the channels intersecting the one or more slots is collinear with the longitudinal axis of the one or more slots.

10. The mold of claim 4, wherein each of the one or more slots has a longitudinal axis and the longitudinal axes of the two channels intersecting the one or more slots are parallel to the longitudinal axis of the one or more slots.

11. The mold of claim 1, wherein the mold is configured as an open-face mold or a close-face mold.

12. The mold of claim 1, wherein the mold comprises at least one of a metal reinforcement or fiber reinforcement.

13. A system for conducting a pullout test on formed composite samples in a cryogenic environment, the system comprising:
a mold, the mold comprising:
a body having a first surface and a second surface spaced apart from the first surface, wherein the first surface defines one or more slots and one or more channels, wherein each of the one or more channels has a longitudinal axis, wherein at least one of the channels intersects at least one of the slots; and
a testing fixture defining a fixture opening, wherein a size and a shape of at least a portion of the fixture opening corresponds to a size and a shape of at least a portion of the one or more slots such that a composite sample formed within the portion of the one or more slots is disposable within the fixture opening.

14. The system of claim 13, further comprising a tensile testing machine, wherein the testing fixture is couplable to the tensile testing machine.

15. A method of forming a composite sample for a pullout test in a cryogenic environment, the method comprising:
providing a mold for forming composite samples for a pullout test, the mold comprising:
a body having a first surface and a second surface spaced apart from the first surface, wherein the first surface defines one or more slots and one or more channels, wherein each of the one or more channels has a longitudinal axis, wherein at least one of the channels intersects at least one of the slots;
disposing a polymer within the one or more slots;
disposing a test material within at least one of the channels intersecting the one or more slots such that a portion of the test material is disposed within the one or more slots; and
causing the polymer to cure.

16. The method of claim 15, further comprising:
removing the test material from the mold;
performing the pullout test on the test material; and
determining, via a testing instrument or at least one electronic circuit, one or more characteristics of the test material during the pullout test.

17. The method of claim 16, wherein the pullout test is a microbond test, fiber-bundle pullout test (FBPO), or single-fiber pullout test (SFPO).

18. The method of claim 16, wherein the pullout test is performed at a temperature between 77 K and 120 K.

19. The method of claim 15, further comprising applying a compression force on the mold prior to causing the polymer to cure.

20. The method of claim 15, wherein the test material comprises an epoxy-metal interface.
